(19) United States
(12) Patent Application Publication
(10) Pub. No.: US 2010/0141184 A1
(43) Pub. Date: Jun. 10, 2010

(54) FAN AND SPEED CONTROL CIRCUIT THEREOF

(75) Inventors: CHING-BAI HWANG, Tu-Cheng (TW); HENG-SHENG LIN, Tu-Cheng (TW); RUNG-AN CHEN, Tu-Cheng (TW); PO-HSUAN KUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/483,265

(22) Filed: Jun. 12, 2009

(30) Foreign Application Priority Data
Dec. 10, 2008 (CN) 200810306081.2

(51) Int. Cl. H02K 7/14

(52) U.S. Cl. 318/3

(57) ABSTRACT

A fan includes a speed control circuit and a motor electrically connected with the speed control circuit. The speed control circuit includes an inputting circuit and a transforming circuit electrically connected with the inputting circuit. The inputting circuit supplies a constant current to the transforming circuit. The transforming circuit transforms the constant current to a fluctuating current and outputs the fluctuating current to the motor of the fan. The fluctuating current causes a rotation with a fluctuating speed to the motor of the fan.

### BACKGROUND

1. Technical Field

The present disclosure generally relates to fans, and particularly to a fan having a speed control circuit for reducing a noise of the fan.

2. Description of Related Art

With continuing development of the electronic technology, electronic components such as CPUs (central processing units) generate more and more heat during operation. If the heat is not well dissipated, the electronic components will be overheated to cause the operation unstable, or even cause the electronic component malfunction or crash. Conventionally, fans are used in combination with heat sinks to dissipate the heat generated by the electronic components.

A typical fan includes a motor and an impeller attached to the motor. The impeller includes a hub and a plurality of blades arranged around the hub.

During operation, the motor is electrified to drive the impeller to rotate. The blades of the impeller disturb the air periodically, which causes a vibration of the air. However, a rotating speed of the motor is usually constant, and thus the vibration of the air generated during rotation of the fan has a constant frequency and is easy to generate vibration superpose, which can significantly enlarge a noise of the fan.

For the said reasons, a fan overcomes the described limitations is desired.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram illustrating a fan according to an exemplary embodiment of the present disclosure.

FIG. 2 is a graph indicating a current input into a transforming circuit of a speed control circuit of the fan and a current output from the transforming circuit of the speed control circuit of the fan.

FIG. 3 is a graph indicating a current output from the transforming circuit in accordance with an alternative embodiment of the present disclosure.

### DETAILED DESCRIPTION

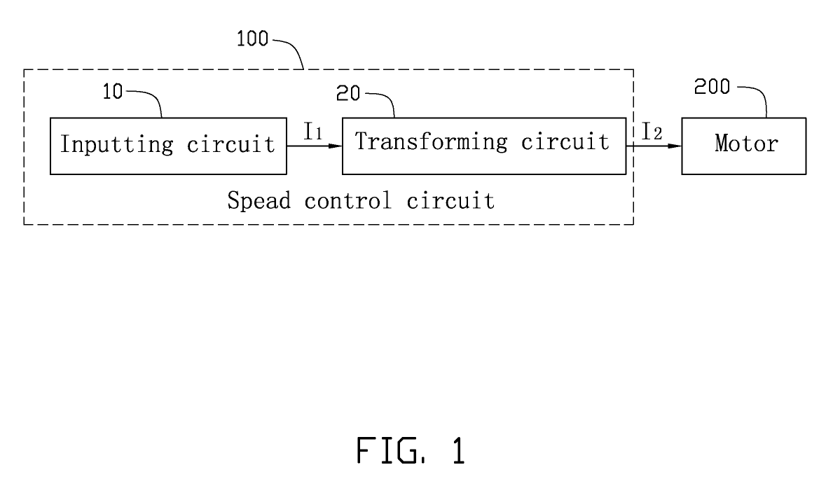

Referring to FIG. 1, a fan according to an exemplary embodiment of the present disclosure includes a speed control circuit 100 and a motor 200 electrically connected to the speed control circuit 100. The speed control circuit 100 includes an inputting circuit 10 and a transforming circuit 20 electrically connected with the inputting circuit 10. The motor 200 is electrically connected with the transforming circuit 20.

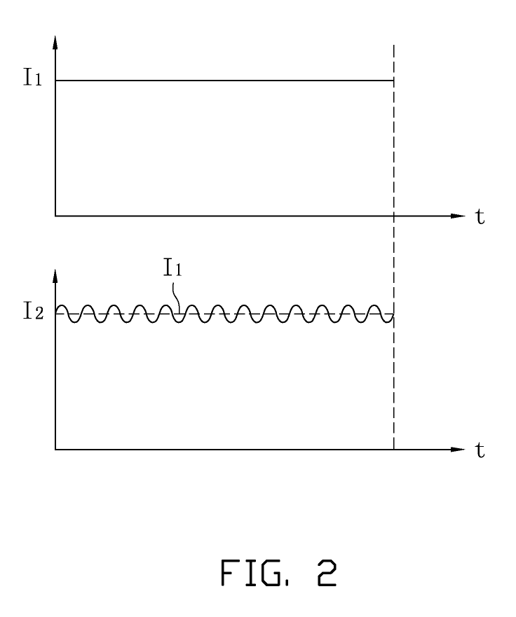

Referring to FIG. 2, the inputting circuit 10 is connected to a power source and outputs a constant current I₁ to the transforming circuit 20. The transforming circuit 20 transforms the constant current I₁ to a fluctuating current I₂ which fluctuates slightly with respect to the constant current I₁. The fluctuating current I₂ is supplied to the motor 200 of the fan to cause and maintain a rotation of the motor 200. In this embodiment, the fluctuating current 12 has a sine wave. Preferably, an amplitude of the sine wave, i.e. a fluctuating range of the fluctuating current I₂ is not larger than 5% of the constant current I₁. In this embodiment, the amplitude of the sine wave of the fluctuating current I₂ is 4% of the constant current I₁.

During operation, the rotating speed of the motor 200 fluctuates due to the fluctuating current I₂. Thus vibration of the air generated during the rotation of the motor 200 has a fluctuating frequency, which weakens the vibration superposes. Therefore the noise of the fan is reduced.

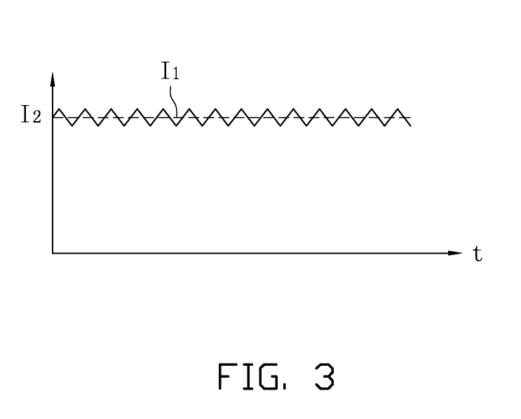

FIG. 3 shows a graph indicating a fluctuating current I₂ output from the transforming circuit 20 in accordance with an alternative embodiment; the fluctuating current I₂ in accordance with this embodiment has a saw-toothed wave.

It is to be understood that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A speed control circuit for a motor of a fan comprising:
an inputting circuit for generating a constant current; and
a transforming circuit electrically connected to the inputting circuit to transform the constant current to a fluctuating current, the fluctuating current being adapted to be supplied to the motor to cause and maintain a rotation of the motor of the fan.

2. The speed control circuit of claim 1, wherein the fluctuating current has one of a sine wave and a saw-toothed wave.

3. The speed control circuit of claim 2, wherein a fluctuating range of the fluctuating current is less than 5% of the constant current.

4. A fan comprising:
a speed control circuit comprising an inputting circuit and a transforming circuit electrically connected with the inputting circuit; and
a motor electrically connected with the transforming circuit;
wherein the inputting circuit supplies a constant current to the transforming circuit, and the transforming circuit transforms the constant current to a fluctuating current and outputs the fluctuating current to the motor of the fan.

5. The fan of claim 4, wherein the fluctuating current has one of a sine wave and a saw-toothed wave.

6. The fan of claim 5, wherein a fluctuating range of the fluctuating current is less than 5% of the constant current.

7. The fan of claim 6, wherein the fluctuating range of the fluctuating current is 4% of the constant current.
